(19) United States
(12) Patent Application Publication
(10) Pub. No.: US 2024/0001392 A1
(43) Pub. Date: Jan. 4, 2024

(54) Trim Paint Stand

(71) Applicants: Christopher Nathan Cole, Kansas City, KS (US); Douglas Lawrence Tree, Bluespring, MO (US)

(72) Inventors: Christopher Nathan Cole, Kansas City, KS (US); Douglas Lawrence Tree, Bluespring, MO (US)

(21) Appl. No.: 17/890,411

(22) Filed: Aug. 18, 2022

Related U.S. Application Data
(62) Division of application No. 29/850,262, filed on Aug. 18, 2022.
(60) Provisional application No. 63/357,581, filed on Jun. 30, 2022.

(51) Int. Cl. B05B 13/02; B44D 3/00

(52) U.S. Cl. CPC B05B 13/0285; B44D 3/00

(57) ABSTRACT

The present invention is a support system made of collapsible stands to hold moulding and trim for the purpose of painting and drying. The stands fold flat for easy storage, setup quickly, and allow the painter to easily paint many pieces of trim on a relatively small footprint compared to what most painters currently use—buckets and 2×4's or sawhorses.

### SEQUENCE LISTING OR PROGRAM

Not Applicable

### TECHNICAL FIELD OF THE INVENTION

The present invention relates in general to aids for painting trim and mouldings. More specifically, the present invention relates to a stand for holding a plurality of trim and moulding pieces to be painted.

### BACKGROUND OF THE INVENTION

When painting contractors and DIYers need to paint loose trim and moulding, they have few options available to assist them in doing so. Currently, the go to method is buckets and 2×4's or sawhorses. While these solutions may work, they are not ideal, and have several inherent problems, especially when needing to paint many pieces of trim. Buckets and 2×4's require the painter to bend low to the ground. In both current methods, the space available for painting is limited since the trim cannot be stacked, requiring the painter to have to wait for the paint to dry before painting more, or try to move the trim to make additional space, running the risk of ruining the paint before it dries.

The present invention solves these problems by allowing the painter to paint several pieces of trim at once on a relatively small footprint. With the present invention, painters can now get a higher quality paint job done in much less time by using two or more multi-tiered shelf supports together, which conveniently hold multiple pieces of trim. This allows the painter to paint multiple pieces of trim in less time, with greater maneuverability, and less effort. Professional painters are limited on space on the job site as well as in their vehicles, so the present invention collapses and folds flat for easy storage.

The present invention can be discarded after each or multiple uses as it has the option to be made out of affordable materials like corrugated paper or plastic. In addition, the present invention is designed to support the weight of several pieces of trim and specifically designed to give access for a sprayer, brush, or roller to fit in between each shelf support.

### SUMMARY OF THE INVENTION

The following is intended to be a brief summary of the invention and is not intended to limit the scope of the invention.

A structure with integrated shelves for the purpose of holding multiple elongated objects.

The structure in paragraph 5 wherein the main body of the structure has a perpendicular cross member to help the structure stand vertically and add stability to the structure.

The structure in paragraph 5 wherein the shelves are designed to hold long objects like moulding and trim.

The structure in paragraph 5 and 7 wherein the support system may be used for painting, drying, and temporarily storing said moulding and trim for a period of time.

The structure in paragraph 7 and 8 wherein the angle above each shelf is between 22.5 and 75 degrees to add structural strength and to allow room for the paint to be applied by a sprayer, brush, or roller.

The structure in paragraph 7 and 8 wherein there is between 2 inches and 24 inches between each vertical shelf to allow for objects which may vary in height.

The structure in paragraph 5 wherein there are shelves on both sides of the support system to aid in weight distribution and balance.

The structure in paragraph 11 wherein there are shelves on both sides to allow for additional objects to be held.

The structure in paragraph 5 wherein the parts of the structure are flat for the purpose of taking up less space when not in use.

The structure in paragraph 5 and 13 wherein the parts of the structure are made out of corrugated paper, plastic, metal or wood for temporary, semi permanent or permanent use.

The structure in paragraph 5, 6 and 13 wherein the main shelf body and the cross-member may be nicked together for manufacturing efficiency and to be sold together as a set.

The structure in paragraph 5 wherein two or more structures are used simultaneously to hold long objects.

The structure in paragraph 5 wherein there is a cutout for a handle for easy transportation of the support system whether empty or loaded.

### BRIEF DESCRIPTION OF THE DRAWINGS

The accompanying drawings, which are incorporated herein and form a part of the specification, illustrate the present invention and, together with the description, further explain the principles of the invention and to enable a person skilled in the pertinent art to make and use the invention.

FIG. 1 shows an example of a die line which may be used to manufacture the present invention, showing two parts, the shelf part and the support part. These two parts may be nicked together.

FIG. 2a shows an example of how the present invention may be sold in a retailer or shipped to the customer. The two parts may remain nicked together as they may be folded together flat.

FIG. 2b shows an example of the present invention being broken apart to be used prior to assembly.

FIG. 2c shows an example of the present invention being assembled by sliding the slot from the shelf part, interlocking it with the slot of the support part.

FIG. 2d shows an example of one assembled stand.

FIG. 2e shows an example of the present invention folded flat for storage before, after or between uses.

FIG. 2f shows an example of a pair of stands being used together as one possible use case, being that of holding several pieces of trim.

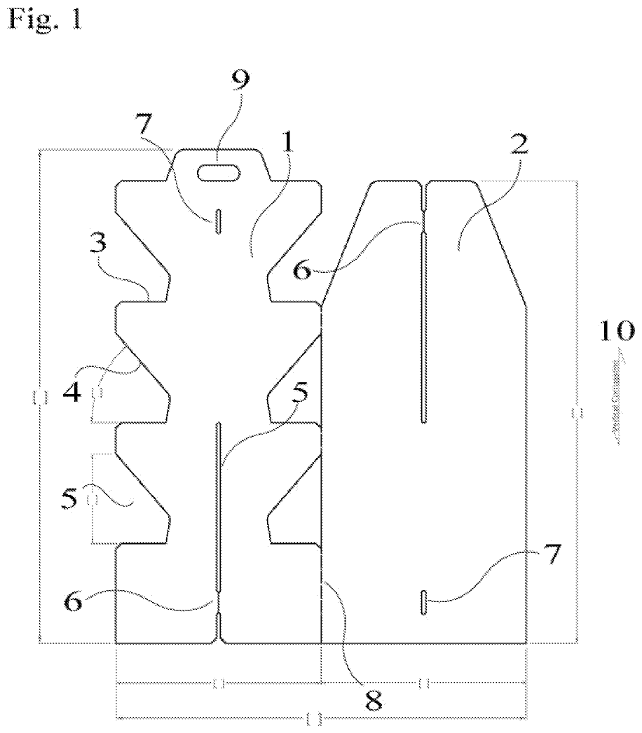

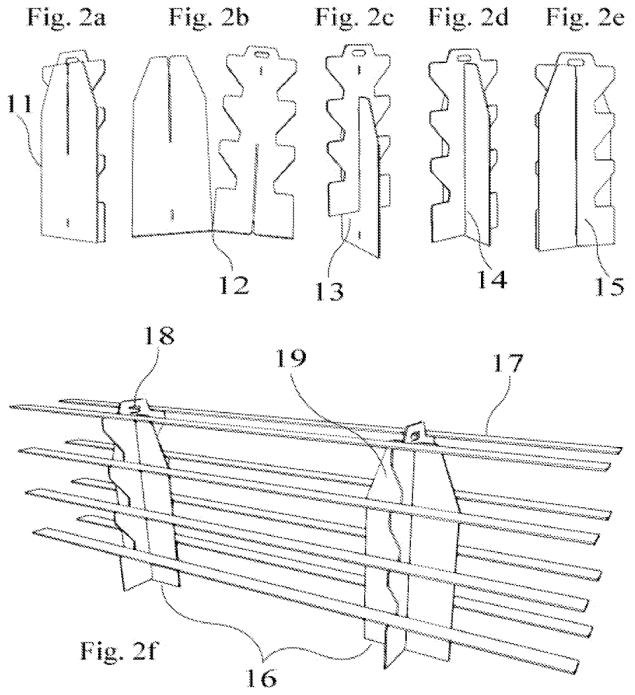

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, specific details are set forth to provide a thorough understanding of the invention. However, it is understood that the invention may be practiced without these specific details. In other instances, well-known structures and techniques known to one of ordinary skill in the art have not been shown in detail in order not to obscure the invention. Referring to the figure, it is possible to see the various major elements constituting the apparatus of the present invention.

The present invention may be manufactured out of various materials depending on the end use. For temporary use, the stand may be manufactured out of corrugated fiberboard or other appropriate material, which would be intended to be discarded after a single or a few uses. For semi-permanent use, the stand may be manufactured out of corrugated plastic, or other appropriate material, which may be used for a longer but limited period of time. For permanent use, the stand could be made out of plastic, metal, wood product, or other appropriate material for an extended period of time.

The stand is made of two parts, the shelf part 1, and the support part 2. The parts may be nicked together 8 or manufactured separately. There may be any number of shelves 3 on a stand, which shelves may vary in depth. The shelves 3 may be on both sides of the shelf part. The angle 4 beneath or above the shelves is between 22.5 degrees and 75 degrees to allow for a variety of use cases and to add support. The angles that make up the shelf part may be chamfered and/or radiused to add strength or make painting easier. The back of each shelf is angled back to limit contact of the object to the stand. The distance between each shelf 5 may vary depending on the object in which the stand is designed to hold and to avoid overspray.

The present invention may connect together using slots 5 designed to interlock together perpendicularly to one another and may lock together using tabs 6 and additional slots 7 to assist in keeping the two parts perpendicular when in use.

A handle 9 may be cut out of the material and may include a crease at the top to assist in comfort to the user.

If a corrugated material is selected, the corrugation direction 10 would run vertically to assist in stacking strength.

The present invention may be cut on a CNC, rotary or flat die cutter or other cutting machine. The manufactured parts may be embossed and/or printed with part number, logo, instructions, or other items as needed.

After manufacturing, the present invention may be unitized flat or folded 11. The present invention may be shipped or sold with both parts together. The parts may be separate or nicked and folded together 11.

If nicked together, the user would be required to separate the two parts 12 by breaking them apart.

The user may connect the two parts together by sliding the slot from the shelf part, interlocking it with the slot of the support part 13, until the bottoms of the two parts are even. The parts may lock together with an additional tab and slot 14.

Two or more stands 16 may be used together to hold objects like moulding and trim 17.

After two stands are assembled and loaded with trim, the painter may paint each row of trim. If using a sprayer, the painter may angle their sprayer in between each row 19 as they are painting each row, allowing for a seamless, single pass.

The handles 18 may be used to carry an individual stand or multiple stands loaded with trim using two or more people. The handles 18 allow for the trim to be transported to a covered location like a garage to keep the painted trim covered while drying.

After each use, the stands may be folded flat 15 with the two parts remaining together for easy transport and faster assembly the next time they are used.

Thus, it is appreciated that the optimum dimensional relationships for the parts of the invention, to include variation in size, materials, shape, form, function, and manner of operation, assembly and use, are deemed readily apparent and obvious to one of ordinary skill in the art, and all equivalent relationships to those illustrated in the drawings and described in the above description are intended to be encompassed by the present invention.

Furthermore, other areas of art may benefit from this method and adjustments to the design are anticipated. Thus, the scope of the invention should be determined by the appended claims and their legal equivalents, rather than by the examples given.

1. A trim paint stand comprising:
a shelf part and
a support part.

2. The trim paint stand of claim 1, wherein
for temporary use, the stand is manufactured out of corrugated fiberboard intended to be discarded after a single or a few uses.

3. The trim paint stand of claim 1, wherein
for semi-permanent use, the stand is manufactured out of corrugated plastic used for a longer but limited period of time.

4. The trim paint stand of claim 1, wherein
for permanent use, the stand is made out of plastic, metal, or wood product for an extended period of time.

5. The trim paint stand of claim 1, wherein
the parts may be nicked together or manufactured separately.

6. The trim paint stand of claim 1, wherein
one or more shelves are located on a stand; and
the shelves may vary in depth.

7. The trim paint stand of claim 1, wherein
the shelves are located on both sides of the shelf part.

8. The trim paint stand of claim 1, wherein
the angle beneath or above the shelves is between 22.5 degrees and 75 degrees to allow for a variety of use cases and to add support.

9. The trim paint stand of claim 8, wherein
the angles that make up the shelf part are chamfered and/or radiused to add strength or make painting easier.

10. The trim paint stand of claim 1, wherein
the back of each shelf is angled back to limit contact of the object to the stand.

11. The trim paint stand of claim 1, wherein
the distance between each shelf varies depending on the object in which the stand is designed to hold and to avoid overspray.

12. The trim paint stand of claim 1, wherein
the parts connect together using slots designed to interlock together perpendicularly to one another; and
lock together using tabs and additional slots to assist in keeping the two parts perpendicular when in use.

13. The trim paint stand of claim 1, wherein
a handle 9 is cut out of the material; and
includes a crease at the top to assist in comfort to the user.

14. The trim paint stand of claim 2 or 3, wherein
the corrugation direction runs vertically to assist in stacking strength.

15. The trim paint stand of claim 1, wherein
the two parts are connected together by:
sliding the slot from the shelf part,
interlocking the slot of the shelf part with the slot of the support part, until the bottoms of the two parts are even.

16. The trim paint stand of claim 15, wherein
the parts lock together with an additional tab and slot.
